(19) United States
(12) Patent Application Publication
(10) Pub. No.: US 2019/0337694 A1
(43) Pub. Date: Nov. 7, 2019

(54) THERMOFORMABLE MULTILAYER MOISTURE BARRIER AND METHOD OF MAKING THE SAME

(71) Applicant: Multisorb Technologies, Inc., Buffalo, NY (US)

(72) Inventor: Narasimharao DONTULA, Rochester, NY (US)

(21) Appl. No.: 16/512,651

(22) Filed: Jul. 16, 2019

Related U.S. Application Data
(63) Continuation of application No. PCT/US2017/013671, filed on Jan. 16, 2017.

(51) Int. Cl. B65D 65/40; B32B 1/02; B32B 27/08; B32B 27/20; B32B 27/30; B32B 27/32; B65D 75/36

(52) U.S. Cl. CPC B65D 65/40; B32B 1/02; B32B 27/08; B32B 27/20; B32B 27/304; B32B 27/32; B29C 48/0017; B32B 2250/05; B32B 2250/24; B32B 2307/7265; B32B 2307/738; B32B 2439/80; B65D 75/367

(57) ABSTRACT

A multilayer structure including, in order, a first passive moisture barrier layer, a second passive moisture barrier layer, a first active moisture barrier layer including a first moisture absorbing composition and a cyclic olefin copolymer, and a third passive moisture barrier layer. The first, second and third passive moisture barrier layers and the first active moisture barrier layer are contiguous, non-contiguous or combinations thereof. A method of forming a moisture absorbing multilayer structure including: a) forming a base structure including, in order, a first passive moisture barrier layer, a first active moisture barrier layer and a second passive moisture barrier layer, the first active moisture barrier layer having a first side and a second side opposite the first side and including a cyclic olefin copolymer, the first passive moisture barrier layer disposed on the first side, and the second passive moisture barrier layer disposed on the second side; and, b) coating a third passive moisture barrier layer on the base structure.

### CROSS REFERENCE TO RELATED APPLICATIONS

This application is a continuation of Int. App. No. PCT/US2017/013671, filed Jan. 16, 2017, the contents of which application is incorporated herein by reference in its entirety.

### FIELD OF THE INVENTION

The invention broadly relates to moisture barriers, more specifically to multilayer moisture barriers including both passive and active moisture barrier layers, and even more particularly to thermoformable multilayer moisture barrier structures including both passive and active moisture barrier layers.

### BACKGROUND OF THE INVENTION

Many applications require a moisture barrier and/or absorber. For example, some pharmaceutical tablets and food products degrade upon exposure to moisture. Preventing or reducing exposure to moisture can prolong the useful life of such items. Hence, packaging materials and separate inserts to packaging often are provided with moisture absorbing and/or barrier characteristics.

Some materials used to make packaging form effective moisture barriers without additional components included. For example, polychlorotrifluoroethylene (PCTFE) is substantially impermeable to water. However, such materials are too expensive for some applications. Moreover, some of these materials are difficult to process, especially thermoforming.

Metal films in combination with blister packaging are also commonly used to provide a moisture barrier for packaged products. However, the combination of metal films and blister packaging presents difficulty with recycling the materials.

Blister packaging, and the like, are used extensively as they provide multiple benefits over other pharmaceutical packaging. For example, it is readily apparent if a person has taken a particular medication thereby providing a simple compliance verification mechanism. Moreover, separately packaged medicaments facilitate minimizing exposure to oxygen and moisture as each separate dose may be used without environmental exposure of other doses.

In view of the foregoing there is a need for a moisture absorbing and/or barrier system that can be formed without degrading its suitability for subsequent thermoforming operations, e.g., forming into packaging such as blisters.

### BRIEF SUMMARY OF THE INVENTION

An embodiment of the present invention broadly comprises a multilayer structure including, in order, a first passive moisture barrier layer, a second passive moisture barrier layer, a first active moisture barrier layer including a moisture absorbing composition and a cyclic olefin copolymer, and a third passive moisture barrier layer. The first, second and third passive moisture barrier layers and the first active moisture barrier layer are contiguous, non-contiguous or combinations thereof.

Another embodiment of the present invention broadly comprises a thermoformed article formed from a multilayer structure including, in order, a first passive moisture barrier layer, a second passive moisture barrier layer, a first active moisture barrier layer including a moisture absorbing composition and a cyclic olefin copolymer, and a third passive moisture barrier layer. The first, second and third passive moisture barrier layers and the first active moisture barrier layer are contiguous, non-contiguous or combinations thereof. The second and third passive moisture barrier layers each include a modulus of elasticity less than or equal to a modulus of elasticity of the first active moisture barrier layer.

In a further embodiment, the present invention broadly comprises a container for extending the shelf life of moisture degradable pharmaceutical products including a thermoformed article formed from a multilayer structure including, in order, a first passive moisture barrier layer, a second passive moisture barrier layer, a first active moisture barrier layer including a moisture absorbing composition and a cyclic olefin copolymer, and a third passive moisture barrier layer. The first, second and third passive moisture barrier layers and the first active moisture barrier layer are contiguous, non-contiguous or combinations thereof. The second and third passive moisture barrier layers each include a modulus of elasticity less than or equal to a modulus of elasticity of the first active moisture barrier layer. The thermoformed article forms a plurality of pill receiving chambers.

In yet a further embodiment, the present invention broadly comprises a method of forming a moisture absorbing multilayer structure including: a) forming a base structure including, in order, a first passive moisture barrier layer, a first active moisture barrier layer and a second passive moisture barrier layer, the first active moisture barrier layer having a first side and a second side opposite the first side and including a moisture absorbing composition and a cyclic olefin copolymer, the first passive moisture barrier layer disposed on the first side, and the second passive moisture barrier layer disposed on the second side; and, b) coating a third passive moisture barrier layer on the base structure.

These and other objects and advantages of the present invention will be readily appreciated from the following description of various embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a top perspective view of an article formed from a thermoformable multilayer moisture barrier structure, i.e., a blister pack;

FIG. 2 is a bottom perspective view of the article of FIG. 1;

FIG. 3 is a cross-sectional view of an embodiment of a thermoformable multilayer moisture barrier structure;

FIG. 4 is a cross-sectional view of an embodiment of a thermoformable multilayer moisture barrier structure;

FIG. 5 is a cross-sectional view of an embodiment of a thermoformable multilayer moisture barrier structure;

FIG. 6 is a cross-sectional view of an embodiment of a thermoformable multilayer moisture barrier structure;

FIG. 7 is a cross-sectional view of an embodiment of a thermoformable multilayer moisture barrier structure;

FIG. 8 is a graphical depiction of the water vapor transmission rate versus time for an example embodiment of the present multilayer structure;

FIG. 9 is a graphical depiction of the total flux of water vapor per sample area versus time for the example embodiment of the present multilayer structure depicted in FIG. 8;

FIG. 10 is a graphical depiction of the water vapor transmission rate versus time for two example embodiments of the present multilayer structure;

FIG. 11 is a graphical depiction of the water vapor transmission rate versus time for an example embodiment of the present multilayer structure;

FIG. 12 is a graphical depiction of the water vapor transmission rate versus time for two example embodiments of the present multilayer structure;

FIG. 13 is a graphical depiction of the water vapor transmission rate versus time for an example embodiment of the present multilayer structure; and,

FIG. 14 is a graphical depiction of the water vapor transmission rate versus time for an example embodiment of the present multilayer structure.

### DETAILED DESCRIPTION OF THE INVENTION

At the outset, it should be appreciated that like reference numbers on different drawing views identify identical, or functionally similar, structural elements of various embodiments of the invention. While the present invention is described with respect to what are presently considered to be certain preferred aspects, it is to be understood that the invention as claimed is not limited to the disclosed aspects.

Furthermore, this invention is not limited to the particular methodologies, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. It should be understood that the use of “or” in the present application is with respect to a “non-exclusive” arrangement, unless stated otherwise. For example, when saying that “item x is A or B,” it is understood that this can mean one of the following: (1) item x is only one or the other of A and B; or, (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element, and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or, a device comprising a second element and a third element.

As used herein, “blister”, “blister pack” and “single dose unit” may be used interchangeably and are intended to refer to structures commonly used to contain single dose of pharmaceutical materials, and all structures similar thereto. “Moisture barrier”, as used herein, is intended to mean a material which impedes the transmission of moisture. Such materials have water vapor transmission rates (WVTR) as dictated by the needs of the overall multilayer structure. For example, some applications may require a WVTR of

$$0.07 \frac{g}{100 {in}^{2} \cdot 24 hrs} ,$$

while other applications may require a lower WVTR such as

$$0.02 \frac{g}{100 {in}^{2} \cdot 24 hrs} .$$

Moisture barrier characteristics may be altered by a variety of means, e.g., applying more layers of moisture barrier materials, applying thicker layers of moisture barrier materials, applying different moisture barrier materials, incorporating different moisture absorbing compositions, etc. It should be appreciated that the foregoing WVTRs are not intended to be limiting, and the WVTR for each particular embodiment is dictated by the needs of the overall multilayer structure. It should be appreciated that WVTR is the steady state moisture transmission time through a packaging system, under specific conditions of temperature and humidity. Test methods, may include but are limited to, use of gravimetric measurement to determine the rate of weight gain as a result of water vapor transmission into the packaging system and subsequent uptake by a desiccant enclosed within the packaging system. Some instruments offered by Mocon and Systech Illinois measure water vapor transmission rate by challenging one side of a sample with a permeant or test gas, e.g., water vapor, while the opposite side of the sample is swept with a carrier gas. Molecules of permeant diffuse through the sample film and are carried to a sensor by the carrier gas. A computer monitors the increase in water vapor in the carrier gas, and reports values of transmission rate. Typical sensors used to measure water vapor concentration are infrared (IR) and phosphorous pentoxide.

As used herein in association with a value, “about”, “approximately” and the like are used interchangeably and intended to mean±10% of the associated value. For example, about 10 wt % is intended to mean values ranging from 9 wt % to 11 wt %.

Although many methods, devices or materials similar or equivalent to those described herein can be used in the practice or testing of the invention, the preferred methods, devices, and materials are now described.

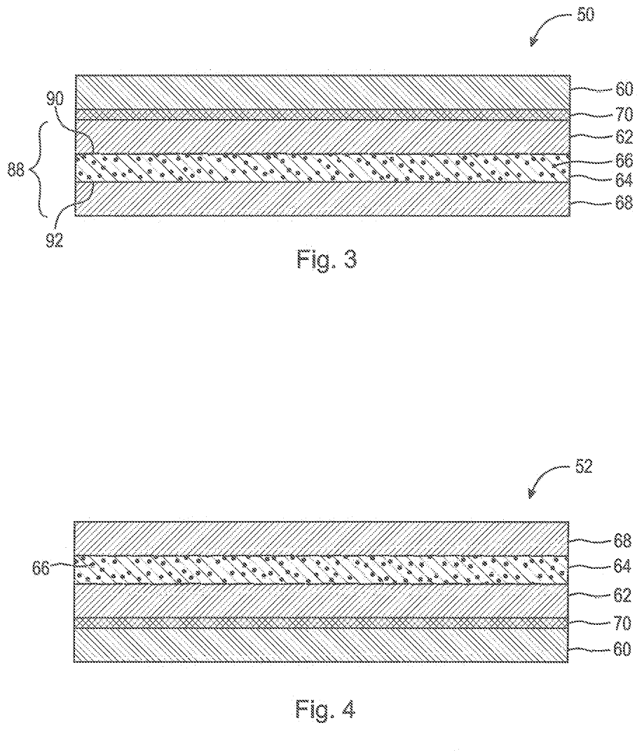

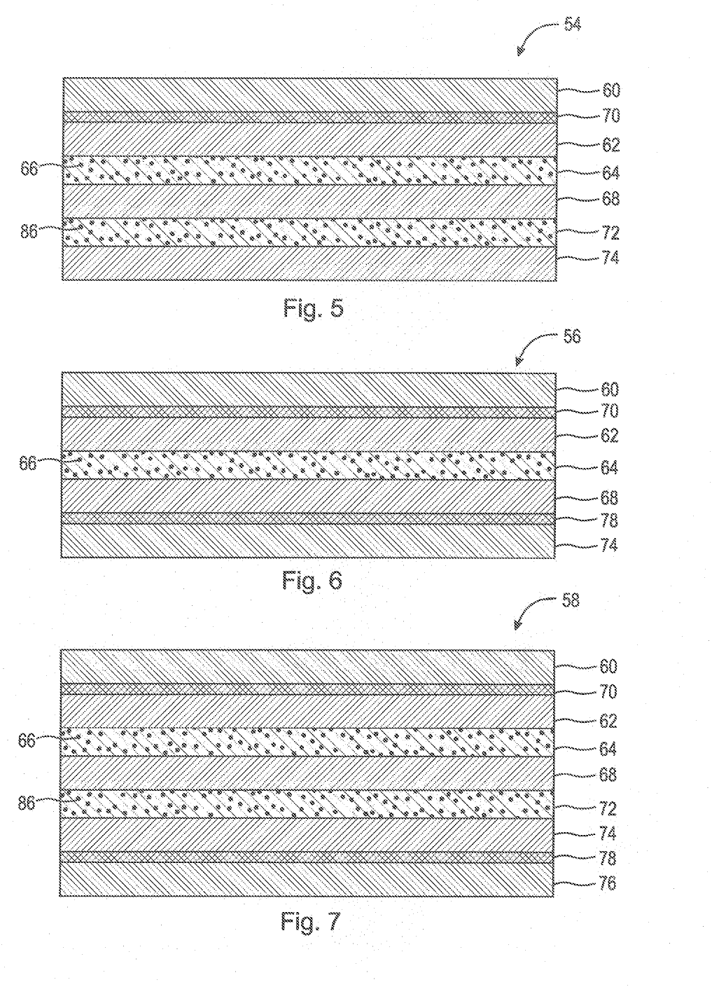

This disclosure includes a new multilayer moisture barrier structure, uses of that structure and methods of forming the structure. In some embodiments, the structure forms a thermoformable passive and active moisture barrier and/or absorber. Some non-limiting examples of a present multilayer structure are depicted in FIGS. 3-7 as multilayer structures 50, 52, 54, 56 and 58.

It should be appreciated that use of terms such as “first”, “second”, “third”, “fourth” and “fifth” in association with the various layers is not intended to be limiting but are included for clarity when referring to the various layers in the specification and the claims. Thus, in some instances, e.g., the discussion of the method of forming a present multilayer structure below, the numerical order reference may need to be different due to the order of introduction of the respective layers in the claims. For example, the first passive moisture barrier layer discussed below with respect to the multilayer structure is the same layer as the third passive moisture barrier layer discussed below with respect to the method of forming the moisture absorbing multilayer structure.

In some embodiments, the multilayer structure, an active and passive moisture barrier, comprises, in order, first passive moisture barrier layer 60, second passive moisture barrier layer 62, first active moisture barrier layer 64, and third passive moisture barrier layer 68. First active moisture barrier layer 64 comprises moisture absorbing composition 66 and a cyclic olefin copolymer. The first, second and third passive moisture barrier layers and the first active moisture barrier layer are contiguous, non-contiguous or combinations thereof.

In some embodiments, the first, second and third passive moisture barrier layers and the first active moisture barrier layer collectively comprise a thickness of less than or equal to about 508 microns. In some embodiments, the present multilayer structure has a ratio of the sum of the thicknesses of the second and third passive moisture barrier layers, i.e., the passive moisture barrier layers immediately adjacent the active moisture barrier layer, to the thickness of the first active moisture barrier layer ranging from 0.18:1 to 0.61:1. In some embodiments, the ratio of the sum of the thicknesses of the active layers to the overall final structure thickness ranges from 0.41:1 to 0.84:1.

It should be appreciated that “contiguous”, as used herein, is intended to mean that each layer is immediately adjacent and contacting the subsequently recited layer in order, while “non-contiguous” is intended to mean that at least one layer in the recited order of layers is not immediately adjacent and contacting the subsequently recited layer. For example, a contiguous arrangement of the embodiment recited above would include a first passive moisture barrier layer adjacent and contacting a second passive moisture barrier layer, which in turn is adjacent and contacting the first active moisture barrier layer, which in turn is adjacent and contacting the third passive moisture barrier layer. Contrarily, a non-contiguous arrangement of the embodiment recited above may include a first passive moisture barrier layer adjacent and contacting a first primer layer, which in turn is adjacent and contacting a second passive moisture barrier layer, which in turn is adjacent and contacting the first active moisture barrier layer, which in turn is adjacent and contacting the third passive moisture barrier layer.

In view of the foregoing, it should be appreciated that the present multilayer structure is thermoformable such that a variety of molded articles may be manufactured using the present structure. An advantage of some embodiments of the present multilayer structure is that they have formulations that in addition to be melt extrudable, are also melt processable via techniques such as injection molding into moisture absorbing containers. An example of such a formulation includes a first passive moisture barrier layer of polyolefin, in addition to a second passive moisture barrier layer, a first active moisture barrier layer and a third passive moisture barrier layer.

In some embodiments, the active moisture barrier layer and closest passive moisture barrier layers to the active moisture barrier layer are co-extruded. For example, passive moisture barrier layers 62 and 68 may be coextruded simultaneously with active moisture barrier layer 64. Moreover, in some embodiments, some or all of the layers in the multilayer structure are separately extruded and then laminated to each other in a subsequent forming operation, e.g., using adhesive, sonic welding, heat, etc.

Various embodiments of the present multilayer structure may also include additional layers within the overall structure. In some embodiments, the present multilayer structure further comprises first primer layer 70 disposed between first passive moisture barrier layer 60 and second passive moisture barrier layer 62. First primer layer 70, first active moisture barrier layer 64 and second and third passive moisture barrier layers 62 and 68, respectively, are co-extruded. In some embodiments, first passive moisture barrier layer 60 is an aqueous solution prior to deposit on first primer layer 70, and in some of those embodiments, first passive moisture barrier layer 60 comprises polyvinylidene chloride (PVDC) and its copolymers. In some embodiments, first passive moisture barrier layer 60 comprises polyvinyl chloride polymer (PVC) and/or amorphous polyethylene terepthalate (APET). In some embodiments including first primer layer 70, the present multilayer structure collectively comprises a thickness of less than or equal to about 508 microns. In some embodiments, first passive moisture barrier layer 60 and first primer layer 70 are co-extruded onto an intermediate multilayer structure comprising, in order, second passive moisture barrier layer 62, first active moisture barrier layer 64 and third passive moisture barrier layer 68.

In some embodiment, the present multilayer structure further comprises, in order after third passive moisture barrier layer 68, second active moisture barrier layer 72 and fourth passive moisture barrier layer 74. Second active moisture barrier layer 72 comprises second moisture absorbing composition 86 and a cyclic olefin copolymer. The first, second, third and fourth passive moisture barrier layers and the first and second active moisture barrier layers are contiguous, non-contiguous or combinations thereof. In some embodiments, first and second active moisture barrier layers 64 and 72, respectively, and second, third and fourth passive moisture barrier layers 62, 68 and 74, respectively, are co-extruded, and the first, second, third and fourth passive moisture barrier layers and the first and second active moisture barrier layers are contiguous, non-contiguous or combinations thereof. In some embodiments, the present multilayer structure including first and second active moisture barrier layers 64 and 72, respectively, and first, second, third and fourth passive moisture barrier layers 60, 62, 68 and 74, respectively, comprises an overall thickness of less than or equal to about 508 microns. In some embodiments, the present multilayer structure including first and second active moisture barrier layers 64 and 72, respectively, and second, third and fourth passive moisture barrier layers 62, 68 and 74, respectively, has a ratio of a sum of the thicknesses of the second, third and fourth passive moisture barrier layers to a sum of the thicknesses of the first and second active moisture barrier layers ranging from 0.18:1 to 0.61:1. Moreover, it has a ratio of the sum of the thicknesses of the active moisture barrier layers to the total thickness of the structure ranging from 0.41:1 to 0.84:1.

In some embodiments, the present multilayer structure further comprises, after fourth passive moisture barrier layer 74, fifth passive moisture barrier layer 76. The first, second, third, fourth and fifth passive moisture barrier layers and the first and second active moisture barrier layers are contiguous, non-contiguous or combinations thereof. In some embodiments, the present multilayer structure further comprises first primer layer 70 disposed between first passive moisture barrier layer 60 and second passive moisture barrier layer 62, and/or second primer layer 78 disposed between fourth passive moisture barrier layer 74 and fifth passive moisture barrier layer 76. In some embodiments, the first and second active moisture barrier layers and the second, third and fourth passive moisture barrier to layers are co-extruded, and the first, second, third, fourth and fifth passive moisture barrier layers and the first and second active moisture barrier layers are contiguous, non-contiguous or combinations thereof.

In some embodiments, at least one of the first and fifth passive moisture barrier layers is an aqueous solution prior to deposit on the second and fourth passive moisture barrier layer, respectively. In some embodiments, at least one of the first and fifth passive moisture barrier layers comprises polyvinylidene chloride (PVDC) and its copolymers. In some embodiments, at least one of the first and second passive moisture barrier layers comprises polyvinyl chloride polymer (PVC) and/or amorphous polyethylene terepthalate (APET). In some embodiments, the present multilayer structure including first and second active moisture barrier layers 64 and 72, respectively, and first, second, third, fourth and fifth passive moisture barrier layers 60, 62, 68, 74 and 76, respectively, comprises an overall thickness of less than or equal to about 508 microns.

In some embodiments, the present multilayer structure further comprises, after third passive moisture barrier layer 68, fourth passive moisture barrier layer 74. The first, second, third and fourth passive moisture barrier layers and the first active moisture barrier layer are contiguous, non-contiguous or combinations thereof. In some embodiments, the first active moisture barrier layer and the second and third passive moisture barrier layers are co-extruded. In some embodiments, the present multilayer structure further comprises first primer layer 70 disposed between first passive moisture barrier layer 60 and second passive moisture barrier layer 62, and/or second primer layer 78 disposed between third passive moisture barrier layer 68 and fourth passive moisture barrier layer 74. In some embodiments, the first and second primer layers, the first active moisture barrier layer and the second and third passive moisture barrier layers are co-extruded. In some embodiments, at least one of the first and fourth passive moisture barrier layers is an aqueous solution prior to deposit on the first and second primer layers, respectively. In some embodiments, at least one of the first and fourth passive moisture barrier layers comprises polyvinylidene chloride (PVDC). In some embodiments, the present multilayer structure including first active moisture barrier layer 64 and first, second, third and fourth passive moisture barrier layers 60, 62, 68 and 74, respectively, comprises an overall thickness of less than or equal to about 508 microns.

Forming Process

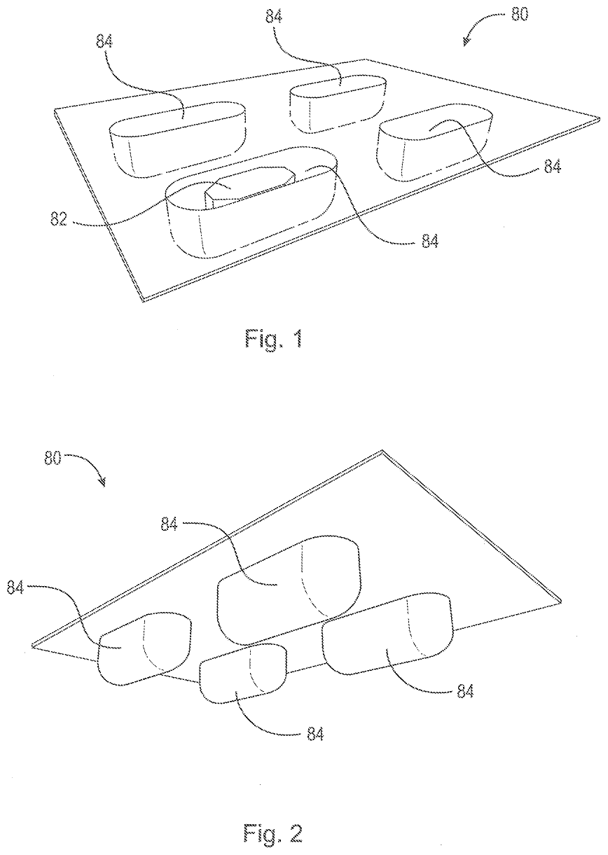

The present structure described above may be formed into a variety of useful articles, e.g., blister packs for pharmaceuticals, trays for food packaging, etc. Blister pack 80 is depicted in FIGS. 1 and 2. The structure may be thermoformed, extrusion molded or formed using any other process known in the art.

In some embodiments, the presently disclosed multilayer structure is used to form a thermoformed article, e.g., blister pack 80. Second and third passive moisture barrier layers 62 and 68, respectively, each comprise a modulus of elasticity less than or equal to a modulus of elasticity of first active moisture barrier layer 64. Although the present multilayer structure may be formed when falling outside of the following glass transition temperature range, it has been found that the thermoformability of the multilayer structure is improved when the glass transition temperature of the polymers used or of the passive moisture barrier layers surrounding the active moisture barrier layer is lower than, equal to or no more than 10° C. greater than the glass transition temperature of the active moisture barrier layer. It was further found that the glass transition temperatures of the various layers should be accounted for in order to ensure a structure will be thermoformable without cracking.

In some embodiments, the thermoformed article is a container for extending the shelf life of moisture degradable pharmaceutical products, e.g., pills 82. In such embodiments, container 80 comprises the thermoformed article forming a plurality of pill receiving chambers 84. Pill 82 is deposited in chamber 84 prior to sealing pack 80 with a sealing layer such as a foil (not shown).

Passive Moisture Barrier Layers 60, 62, 68, 74 and 76

Passive moisture barrier layers provide resistance to the transmission of moisture through such layers due to the characteristics of the materials used to form each respective layer. In some embodiments, at least one of the first, second, third, fourth and fifth passive moisture barrier layers is selected from the group of: polyethylene (PE); polyvinylidene chloride (PVDC) and its copolymers; ethylene vinyl alcohol (EVOH); polychlorotrifluoroethylene (PCTFE); polyvinyl chloride (PVC); polypropylene (PP); polyethylene terephthalate glycol-modified (PETG); amorphous polyethylene terepthalate (APET); polycarbonate; polyolefin; polyolefin copolymers; cyclic olefin copolymer (COC); high impact polystyrene (HIPS); acrylonitrile butadiene styrene (ABS); bi-axially oriented polyethylene terephthalate (BOPET); polystyrene; oriented polypropylene (OPP); polyesters; acrylonitrile-methyl acrylate copolymers; ethylene vinyl acetate (EVA); and, combinations thereof. In various embodiments and applications, the foregoing materials have been found to provide acceptable values of water vapor transmission rates, i.e., the materials act as suitable passive moisture barriers.

In some embodiments, the outermost passive moisture barrier layer or layers, e.g., passive moisture barrier layers 60, 74, 76, 60 and 76, or 60 and 74, depending on which embodiments are considered, may each be in the form of an aqueous solution prior to deposit on the respective adjacent passive moisture barrier layer. In some embodiments, the outermost passive moisture barrier layer or layers, e.g., passive moisture barrier layers 60, 74, 76, 60 and 76, or 60 and 74, depending on which embodiments are considered, the respective outermost passive moisture barrier layer or layers comprises polyvinylidene chloride (PVDC) or copolymers. The outermost passive moisture barrier layer may be polyvinyl chloride (PVC), amorphous polyethylene terepthalate (APET), and/or ethylene vinyl acetate (EVA) copolymer.

Active Moisture Barrier Layers 64 and 72

Active moisture barrier layers provide resistance to the transmission of moisture through such layers due to a chemical reaction with or absorption of water molecules as they propagate within the layer. Additionally, as described above with respect to the passive moisture barrier layers, some resistance to transmission of moisture is also obtained from the material used to form the active moisture barrier layer. It has been found that active moisture barrier layers in the present multilayer structure comprising a cyclic olefin copolymer are beneficial, e.g., provide passive moisture barrier characteristics while also providing a medium for carrying an active moisture absorbing composition, and permitting subsequent thermoformability of the multilayer structure after the initial formation thereof.

In contrast to the semi-crystalline polyolefins, e.g., PE and PP, cyclic olefin copolymers consist of amorphous, transparent copolymers based on cyclic olefins and linear olefins. Cyclic olefin copolymers are a class of polymeric materials having property profiles that can be varied over a wide range during polymerization. Various grades of cyclic olefin copolymer have glass transition temperatures that vary based on norbornene content. Four commercial sources of cyclic olefin resin are available under the TOPAS®, APEL®, ZEONOR®, ZEONEX®, and ARTON® brand names, supplied by Topas Advanced Polymers, Mitsui Chemicals, Zeon Chemical and Japan Synthetic Rubber, respectively. TOPAS® COC is a random copolymer of ethylene and norbornene. Norbornene is synthesized via the Diels-Alder reaction of ethylene and cyclopentadiene. Polymerization of ethylene and norbornene using metallocene catalysts produces cyclic olefin copolymer. Bulky cyclic rings randomly distributed in an ethylenic backbone prevent crystallization of the ethylene units, creating an amorphous morphology. COC grades are distinguished by glass transition temperature and molecular weight. Glass transition temperature (Tg) depends on the mole percent of norbornene. The typical commercial Tg range is between 33° C. and 170° C. COC has many key property attributes, including but not limited to, exceptional moisture and aroma barrier, chemical resistance, transparency, purity, stiffness and strength.

A disadvantage of COC is that it has a high modulus, a high stiffness, and a low elongation to break, typically less than 15%. Addition of filler materials to polymers increases their modulus and stiffness and makes them more brittle. Active moisture absorbing compositions are also fillers. So, addition of active moisture absorbing ingredients has the same effect of increasing modulus and making the polymer more brittle. To minimize the increase in modulus of filled COC, blends of COC may be used. The blends may be miscible or have low miscibility. Some suitable polymers that may be added to COC include but are not limited to: polyolefins, e.g., high density polyethylene (HDPE), low density polyethylene (LDPE), linear-low density polyethylene (LLDPE); elastomers, e.g., styrene-ethylene/butylene-styrene (SEBS); and, flexible amorphous or semicrystalline copolymers of COC. An example of an elastomeric form of COC is TOPAS® E-140, a grade offered by Ticona. The elastomeric form has an elongation to break of greater than 300%. In view of the foregoing, it should be appreciated that blends of COC with other polymers to compensate for the increase in stiffness of COC on addition of a filler, e.g., a moisture absorbing composition, may be beneficial and/or necessary.

In some embodiments, at least one of the first and second active moisture barrier layers is selected from the group of: polypropylene (PP); amorphous polyester (APET); ethylene vinyl acetate (EVA); and, combinations thereof. However, it should be appreciated that other materials may also be used in the active layer, and the present structure is not limited to these materials.

The active moisture barrier layers further comprise a moisture absorbing composition. In some embodiments, the moisture absorbing composition is present in the range of greater than about 10 wt % to less than or equal to about 35 wt %. In some embodiments, the moisture absorbing composition is selected from the group of: calcium oxide; silica gel; molecular sieve; and, combinations thereof. In some embodiments, each active moisture barrier layer may contain a unique moisture absorbing composition, e.g., moisture absorbing composition 66 and 86 are different, while in some embodiments, each active moisture barrier layer may contain the same moisture absorbing composition, e.g., moisture absorbing composition 66 or 86 are the same.

Primer Layers 70 and 78

The primer layers are included to perform the function of an adhesive or to enable or enhance adhesion between adjacent layers. The term “primer layer” may be used interchangeably with the term “adhesive layer” or “sealant layer”. Suitable primer layer materials, include but are not limited to: ethylene vinyl acetate (EVA) copolymers; maleic anhydride modified polyolefins; copolymers of ethylene, e.g., ethylene methyl acrylate (EMA), ethylene butyl acrylate (EBA), and ethylene ethyl acrylate (EEA); copolymer of ethylene and glycidyl methacrylate; terpolymers of ethylene, methyl acrylate and glycidyl methacrylate; terpolymer of ethylene, butyl acrylate and glycidyl methacrylate; blends of polyolefins; and, combinations thereof.

It should be appreciated that for some applications, some of the foregoing layers may be non-thermoformable or all of the layers may be non-thermoformable. For example, some layers may be applied via non-thermoforming means, e.g., spraying, vapor depositing, etc. Such variations fall within the scope of the claims below.

Methods of Forming the Present Structure

The presently disclosed multilayer structure may be formed using a variety of embodiments. The following include some non-limiting example embodiments.

In some embodiments, a method of forming a present moisture absorbing multilayer structure comprises: a) forming a base structure, e.g., base structure 88, comprising, in order, a first passive moisture barrier layer, e.g., passive moisture barrier layer 62, a first active moisture barrier layer, e.g., active moisture barrier layer 64, and a second passive moisture barrier layer, e.g., passive moisture barrier layer 68, the first active moisture barrier layer having a first side, e.g., side 90, and a second side opposite the first side, e.g., side 92, and comprising a first moisture absorbing composition, e.g., moisture absorbing composition 66, and a cyclic olefin copolymer, the first passive moisture barrier layer disposed on the first side, and the second passive moisture barrier layer disposed on the second side; and, b) coating a third passive moisture barrier layer, e.g., passive moisture barrier layer 60, on the base structure. In some embodiments, the third passive moisture barrier layer, e.g., passive moisture barrier layer 60, is disposed on a side of the first passive moisture barrier, e.g., passive moisture barrier layer 62, opposite the first active moisture barrier, e.g., active moisture barrier layer 64.

In some embodiments, the third passive moisture barrier layer, e.g., passive moisture barrier layer 60, is in the form of an aqueous solution prior to the step of coating on the base structure, e.g., base structure 88. In some embodiments, the third passive moisture barrier layer comprises polyvinylidene chloride (PVDC) and its copolymers.

In some embodiments, the method of forming a present moisture absorbing multilayer structure further comprises: forming a first primer layer, e.g., primer layer 70, on the base structure, e.g., base structure 88, prior to coating the base structure with the third passive moisture barrier layer, e.g., passive moisture barrier layer 60. The first primer layer is disposed between the third passive moisture barrier layer and the base structure. In some embodiments, the step of forming the base structure comprises co-extruding the first active moisture barrier layer, the first and second passive moisture barrier layers and the first primer layer.

In some embodiments, the method of forming a present moisture absorbing multilayer structure further comprises: c) forming the base structure with the third passive moisture barrier layer coated thereon into a molded form. In some embodiments, the molded form is a blister film, and in some embodiments, the step of forming is performed using a thermoforming apparatus.

In some embodiments, the step of forming the base structure comprises co-extruding the first active moisture barrier layer and the first and second passive moisture barrier layers. In some embodiments, the step of forming the base structure comprises independently extruding each of the first active moisture barrier layer and the first and second passive moisture barrier layers and subsequently laminating, e.g., adhering, the first passive moisture barrier layer, the first active moisture barrier layer and the second passive moisture barrier layer to form the base structure by means known in the art.

It should be appreciated that the method of forming the present moisture absorbing multilayer structure may be performed using a variety of techniques and arrangements of steps. In some embodiments, two or more layers may be co-extruded. For example, a base structure including two passive moisture barrier layers on opposite sides of an active moisture barrier layer may be co-extruded, or a structure including in order, a primer layer, a passive moisture barrier layer, an active moisture barrier layer and a passive moisture barrier layer may be co-extruded. Additionally, in some embodiments, each layer or sub-combination of layers may be extruded separately and subsequently laminated or adhered to each other. For example, each passive moisture barrier layer, active moisture barrier layer and primer layer may be separately extruded followed by a subsequent laminating or adhering process wherein the overall multilayer structure is formed in accordance with the various embodiments described above. Moreover, some layers may be coated on other layers or intermediate structures. For example, the primer layers and/or outer most passive moisture barrier layers may be initially formed in a solution and subsequently coated on an intermediate multilayer structure, e.g., base structure 88. It should be further appreciated that the foregoing examples are not intended to be limiting and other variations and combinations are also possible.

The following is an embodiment of a method of forming moisture absorbing multilayer structures. The methods described herein, including quantities of materials, temperatures, pressures, times, etc. are not intended to be limiting and are included merely as examples of suitable conditions/compositions for use in forming some embodiments the present structure.

Resin compositions with various additives are mixed in a co-rotating intermeshing twin screw extruder, e.g., the ZSK-25 from Coperion Corporation or ZSK-27 from American Leistritz. Resin compositions are extruded using a coextrusion setup that enables multilayer extrusion. For some variations, a multi-manifold die is used to form the multilayer structure, while in some instances, a feedblock die is used to form the multilayer structure. In some instances, each layer is extruded separately using a single layer extrusion and the layers subsequently laminated together. Coextrusion of multiple layers enables efficient productivity and was found to enhance the latitude of polymers that can be used for creating the multilayer structure.

For the examples described below, the active moisture barrier layer was made from a cyclic olefin copolymer TOPAS® 8007. The active moisture barrier layer also contained cyclic olefin copolymer elastomer TOPAS® E-140. Furthermore, in order to demonstrate the benefit of an active moisture barrier layer, i.e., a layer including a moisture absorbing composition, calcium oxide was incorporated in the active layer. A variety of grades are available commercially, e.g., Mississippi Lime's POLYCAL® OFT15, a typical grade. Dispersing aids may be included. The second and third passive moisture barrier layers are blends of polyolefins which were compounded on a compounder. For the examples set forth below, the polyolefins are Flint Hills Resources Polypropylene PDP4G3Z03960 and blends of polypropylene with copolymers and elastomers. An example of a copolymer is the INFUSE® 9500 offered by Dow Chemical, an olefin block copolymer which contains alternating blocks of hard (highly rigid) and soft (highly elastomeric) segments. The choice of polymers used in the second and third passive moisture barrier layers and additional component is based on the constraint that their modulus is less than or equal to the modulus of the active moisture barrier layer. Ethylene vinyl acetate copolymer was used as an example of a primer layer. These polymers are available as melt processable grades or solution coating grades. An example of melt processable grade is Repsol's EVA-PA420L. An example of solution coatable grade is DUR-O-SET® E351 which is a low VOC, polyvinyl alcohol stabilized vinyl acetate ethylene copolymer emulsion. For some examples, a passive moisture barrier layer of a PVDC latex was used and aqueous coating techniques were applied. An example of PVDC latex is Owensboro Specialty Polymers, Inc. DARAN® SL112. Other similar grades offered by Owensboro or other companies can be used.

Sheets and films were created and characterized for water vapor transmission rate on a Mocon PERMATRAN-W® 3/33 unit. The sheets and films were characterized under 23° C. and 90% RH, which is an accelerated condition of humidity with respect to 23° C. having 50% RH as its typical ambient condition. As used herein, a “film” is a material that is less than or equal to 10 mil (254 microns) thick and a “sheet” is a material that is greater than 10 mil (254 microns) in thickness. The present structure was tested for performance characteristics under accelerated conditions for a flat film embodiment and a blister pack embodiment.

### Example 1

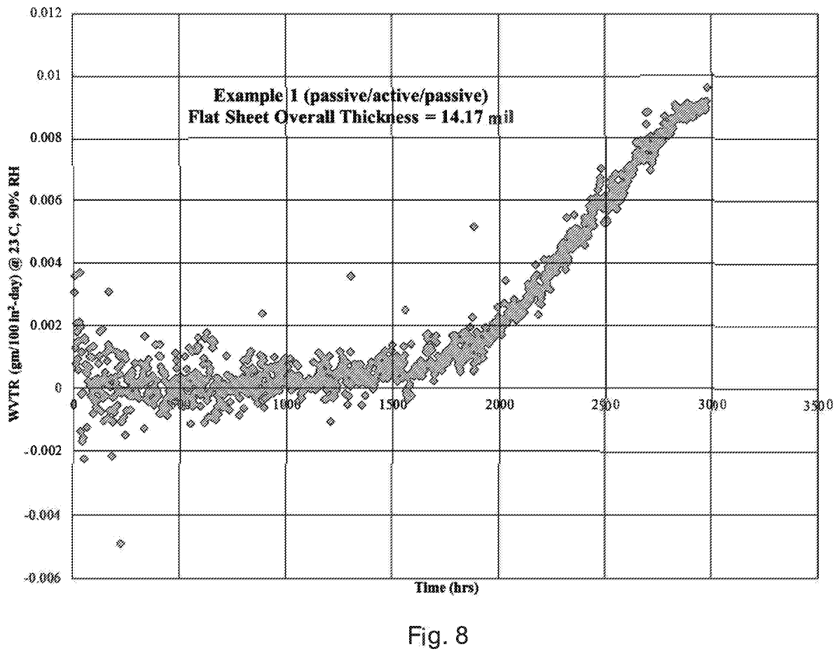

A three layer base structure was made. The structure included: a passive moisture barrier layer/an active moisture barrier layer/a passive moisture barrier layer. The active moisture barrier layer included 59.2 wt % TOPAS® 8007S-04, 14.8 wt % TOPAS® E140, 25 wt % POLYCAL® OFT15 calcium oxide, and 1 wt % EPOLENE® E14P (a dispersing aid offered by Westlake Chemicals). The passive moisture barrier layer included 80 wt % Flint Hills Polypropylene PDP4G3Z03960 (FHR) and 20 wt % Dow INFUSED 9500. The three layers were co-extruded using a multi-manifold setup, where the resins were processed using lab scale extruders manufactured by Killion and Davis Standard. Sheets of various total thicknesses were made. The total sheet thicknesses ranged from 13 mil to 16 mil. This was accomplished by keeping the extruders at the same output while varying the takeup speed. FIG. 8 shows data for a flat sheet having a total thickness of 14.17 mil, with the passive moisture barrier layers being 1.68 mil and 1.35 mil, surrounding a 11.14 mil thick active layer. The resulting structure had a ratio of the sum of the thicknesses of the passive moisture barrier layers to the active moisture barrier layer thickness of 0.27:1.

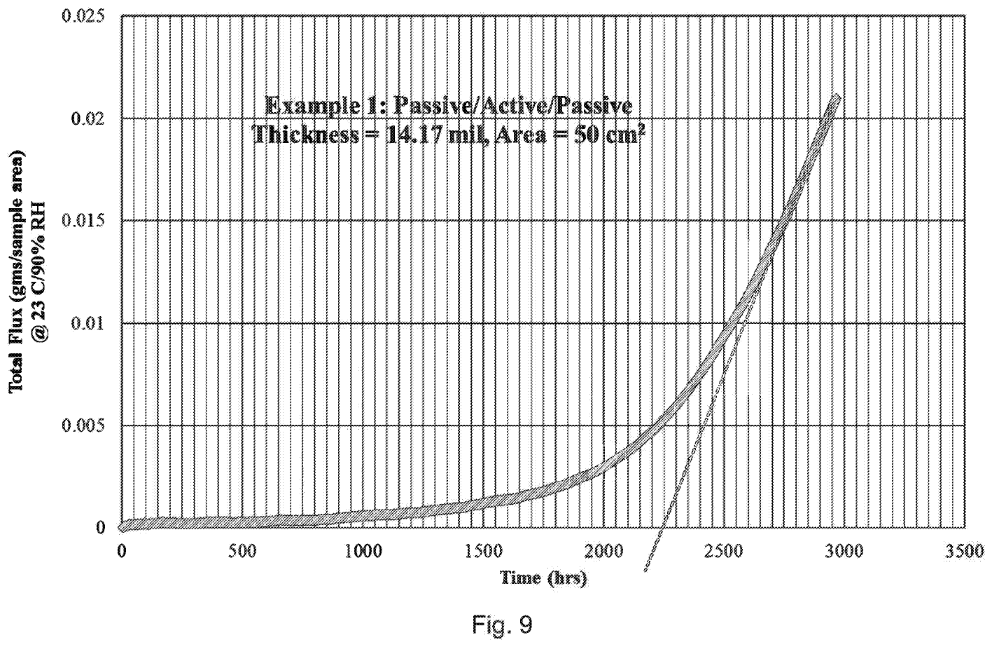

From FIG. 8, it is observed that due to the presence of an active moisture barrier layer, the MVTR is nearly zero at the onset of testing. As the active moisture barrier layer composition gets consumed, there is an increase in MVTR until it approaches a maximum value. The beginning of reaching the maximum, i.e., after the calcium oxide is consumed, is shown in FIG. 8. This maximum value corresponds to a final passive moisture barrier resistance offered by the structure. FIG. 9 depicts the integral of the curve in FIG. 8 plotted against time. Hence, the ordinate axis is the total flux or amount of moisture which the three layer structure has permitted to pass therethrough. FIG. 9 shows a curve which is nearly parallel to the abscissa axis and then changes slope. The intercept on the abscissa axis of a tangent to the curve highlights the “time lag”, i.e., a measure of when moisture will breakthrough or permeate the structure so as to be registered by the Mocon unit in this instance, or the sample being affected by moisture. In this testing, the time lag was found to be 93.75 days at 23° C. and 90% RH, which extrapolates to a time lag of 168.75 days at 23° C. and 50% RH. In view of the test results, a substance can be protected from moisture for about 168 days at ambient conditions, even without using foil, when using the multilayer structure of Example 1. In this example, all three layers were coextruded in one step thereby simplifying manufacturing operations. This result is also different from any purely passive barrier non-foil structures which are commercially available. Furthermore, the resins used in this example are primarily polyolefins and copolymers thereof.

### Example 2

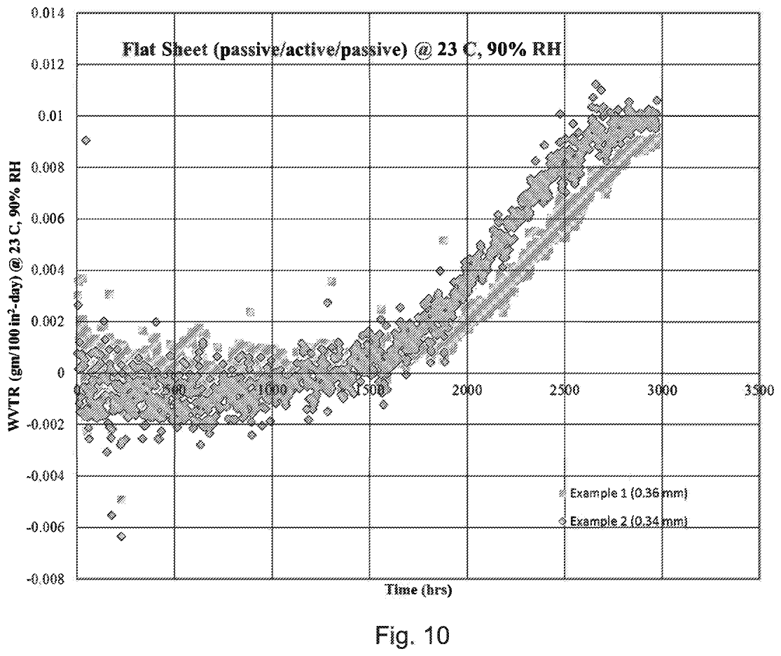

A three layer base structure was made. The structure included: a passive moisture barrier layer/an active moisture barrier layer/a passive moisture barrier layer. The active moisture barrier layer included 59.2 wt % TOPAS® 8007S-04, 14.8 wt % TOPAS® E140, 25 wt % POLYCAL® OFT15 calcium oxide, and 1 wt % EPOLENE® E14P (a dispersing aid offered by Westlake Chemicals). The passive moisture barrier layer included 70 wt % Flint Hills Polypropylene PDP4G3Z03960 (FHR) and 30 wt % Dow INFUSED 9500. The layers were co-extruded using a multi-manifold setup, where the resins were processed using lab scale extruders manufactured by Killion and Davis Standard. Sheets of various total thicknesses were made. The total sheet thicknesses ranged from 13 mil to 16 mil. This was accomplished by keeping the extruders at the same output while varying the takeup speed. Flat sheets were tested for WVTR. FIG. 10 is a graph of WVTR as a function of time for a structure defined by passive layers of 1.6 mil and 1.64 mil thickness surrounding a 10.15 mil thick active layer. In this structure, a ratio of the sum of the thicknesses of the passive moisture barrier layers to the thickness of the active moisture barrier layer was 0.32:1. FIG. 10 compares structures made in Example 1 and 2. It is seen that both have similar characteristics, and within the composition range of passive moisture barrier layers investigated, the WVTR characteristics are similar.

### Example 3

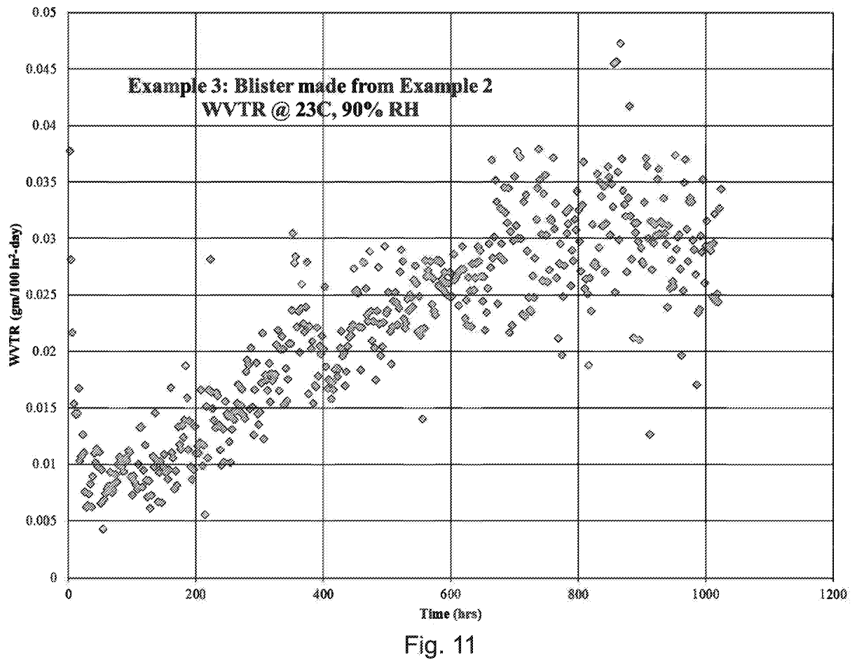

The sheet made in Example 2 was drawn to form blisters using a vacuum thermoformer Formech 508. The blisters were characterized for thickness and thickness uniformity using Magna-Mike 8500. WVTR was characterized on the blisters. Four blisters were tested at the same time. The average thickness of each blister was 3.77 mil. The total blister film area being exposed to moisture was 11.7 cm². FIG. 11 shows WVTR as a function of time. It is seen that due to decrease in the overall thickness of the structure, the time range corresponding to the maximum corresponding to near zero MVTR is smaller than that for a flat sheet (see FIG. 10 vs. 11). FIG. 11 also shows that after the active ingredient is fully consumed, the blister starts to achieve a near constant WVTR which is a function of the passive barrier characteristics of the resins used.

### Example 4

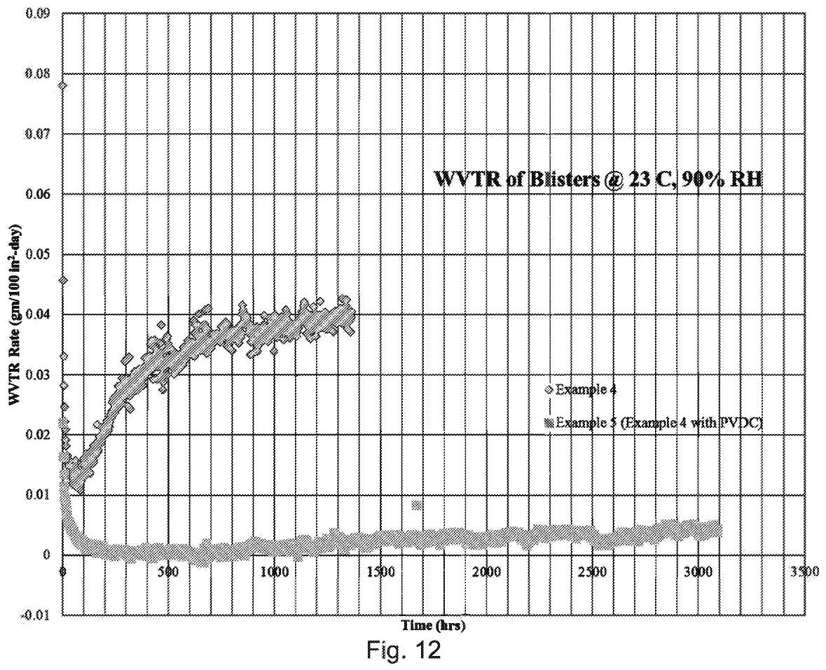

This example investigated the WVTR of blisters made from a three layer coextruded base structure including: a second passive moisture barrier layer/an active moisture barrier layer/a third passive moisture barrier layer. The layers were extruded on a lab coextrusion setup that had two 1″, L:D::24:1 single screw extruders and a ¾″, L:D::24:1 single screw extruder. The resins were extruded through a three layer ULTRAFLOW® I feedblock into an 8″ EDI ULTRAFLEX™ die via adapters. The sheet was cast on a cast roll, and subsequently cooled and wound to form a roll. The roll was then cut to form sheets. The active moisture barrier layer included 59.2 wt % TOPAS® 8007S-04, 14.8 wt % TOPAS® E140, 25 wt % POLYCAL® OFT15 calcium oxide, and 1 wt % EPOLENE® E14P (a dispersing aid offered by Westlake Chemicals). The second and third passive moisture barrier layers included 80 wt % Flint Hills Polypropylene PDP4G3Z03960 (FHR) and 20 wt % Dow IINFUSE® 9500. The target total thickness of the structure was 13 mil, with the passive moisture barrier layers being 1 mil each surrounding an 11 mil thick active moisture barrier layer. This structure resulted in the ratio of the sum of the thicknesses of the passive moisture barrier layers adjacent to active layer to the thickness of the active moisture barrier layer of 0.18:1. The sheet was thermoformed to a blister. The thickness of the blister was 3.77 mil. The total blister film area exposed to moisture was 11.7 cm². WVTR of the blisters was characterized and depicted in FIG. 12.

### Example 5

This example investigated the effect of coating a passive moisture barrier layer on the base structure made in Example 4. The final resulting structure included: a first passive moisture barrier layer/a primer layer/a second passive moisture barrier layer/an active moisture barrier layer/a third passive moisture barrier layer. The first passive moisture barrier layer was made up of DARAN® SL112 and applied as an aqueous coating. The target dry coverage for the first passive moisture barrier layer was 85.2 grams/m². The first passive moisture barrier layer was applied on an aqueous coated primer layer that was previously applied onto the second passive moisture barrier layer. The primer layer was made up of DUR-O-SET® E351 and its target dry coverage was 10.4 grams/m². As determined by taking a cross-section of the resultant structure, the thicknesses of each layer in order from the first passive moisture barrier layer are 1.85 mil, 0.31 mil, 1.02 mil, 11.34 mil, and 1.02 mil, respectively. The total thickness of the structure is 15.55 mil. This structure results in a ratio of the sum of the thicknesses of the passive moisture barrier layers adjacent to active layer to the active moisture barrier layer thickness of 0.18:1, while the ratio of the active moisture barrier layer thickness to the total structure thickness is 0.73:1. The sheet was thermoformed to a blister such that the PVDC layer, i.e., the first passive moisture barrier layer, was the side opposite from the side forming cavities. The PVDC side was exposed to moisture in the WVTR test units and WVTR as a function of time was characterized and depicted in FIG. 12. The average thickness of the blisters was 3.99 mil, while the total blister film area being exposed to moisture was 11.7 cm². FIG. 12 shows an example of the effect of applying a passive moisture barrier layer to the base structure. It was observed that the effectiveness of the active moisture barrier layer is enhanced and the WVTR is nearly zero in the time frame of the test.

### Example 6

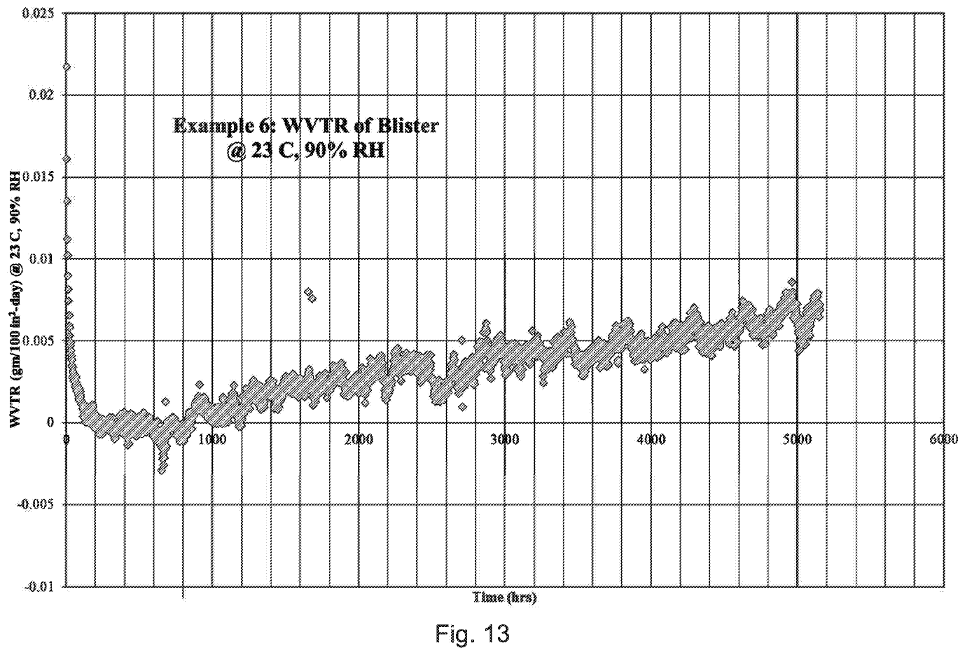

This example differs from Example 5 by showing the effect of increasing the active moisture absorbing composition on WVTR. Data included herein is only for blisters made from the example multilayer structure. The structure characterized included: a first passive moisture barrier layer/a second passive moisture barrier layer/an active moisture barrier layer/a third passive moisture barrier layer. The base three layer coextruded structure was made on the feedblock setup described in Example 4. In this example, the active moisture barrier layer included 50.92 wt % TOPAS® 8007S-04, 12.7 wt % TOPAS® E140, 35 wt % POLYCAL® OFT15 calcium oxide, and 1 wt % EPOLENE® E14P (a dispersing aid offered by Westlake Chemicals). The passive moisture barrier layers immediately surrounding the active moisture barrier layer included 80 wt % Flint Hills Polypropylene PDP4G3Z03960 (FHR) and 20 wt % Dow INFUSED 9500. The target total thickness of the structure was 13 mil, with the passive moisture barrier layers being 1 mil each surrounding an 11 mil thick active moisture barrier layer. This structure results in a ratio of the sum of the thicknesses of the passive moisture barrier layers adjacent to the active moisture barrier layer to the active moisture barrier layer thickness of 0.18:1. Rolls of the foregoing example composition were created and subsequently aqueous coated with a primer layer on one side. The primer layer used was DUR-O-SET® E351 and its target dry coverage was 10.4 grams/m². PVDC was coated at a target coverage of 85.2 grams/m² on the side the primer layer was coated. The final structure included: a first passive moisture barrier layer/a second passive moisture barrier layer/an active moisture barrier layer/a third passive moisture barrier layer. The sheet was thermoformed to a blister. The average thickness of the blisters was 3.71 mil. The ratio of the thickness of the active moisture barrier layer to the total thickness was 0.72:1, while the ratio of the sum of the thicknesses of the passive moisture barrier layers immediately surrounding the active moisture barrier layer to the thickness of the active moisture barrier layer was 0.2:1. The total blister film area being exposed to moisture was 11.7 cm². The PVDC side was exposed to moisture in the WVTR testing units and WVTR as a function of time was characterized and depicted in FIG. 13.

### Example 7

This example investigated the thermoformability of the structure including: a first passive moisture barrier layer/a second passive moisture barrier layer/an active moisture barrier layer/a third passive moisture barrier layer. The composition of each layer was the same as set forth in Example 5. The dry thickness coverage of the first passive moisture barrier layer was 85.5 grams/m² and the primer layer was 12.96 grams/m², i.e., both similar to Example 5. The second and third passive moisture barrier layers were 1.79 mil and 1.85 mil, respectively, i.e., thicker than in Example 5. The active moisture barrier layer was 8.87 mil thick, i.e., thinner than in Example 5. This structure resulted in a ratio of the sum of the thicknesses of the passive moisture barrier layers adjacent to the active moisture barrier layer to the thickness of the active moisture barrier layer thickness of 0.41:1. The thermoformed blister structures, having an average thickness of 3.76 mil, demonstrated good WVTR characteristics.

### Example 8

This example investigated the manufacture of the following coextruded structure: a second passive moisture barrier layer/a first active moisture barrier layer/a third passive moisture barrier layer/a second active moisture barrier layer/a fourth passive moisture barrier layer, and investigated its ability to be thermoformed to form blisters. The thickness of the layers were 1.48 mil, 6.14 mil, 1.63 mil, 6.24 mil, and 0.77 mil, respectively. The ratio of the sum of the thicknesses of the passive moisture barrier layers to the sum of the thicknesses of the active moisture barrier layers was 0.31:1. The composition of this structure was thermoformed successfully to form blisters without cracking.

### Example 9

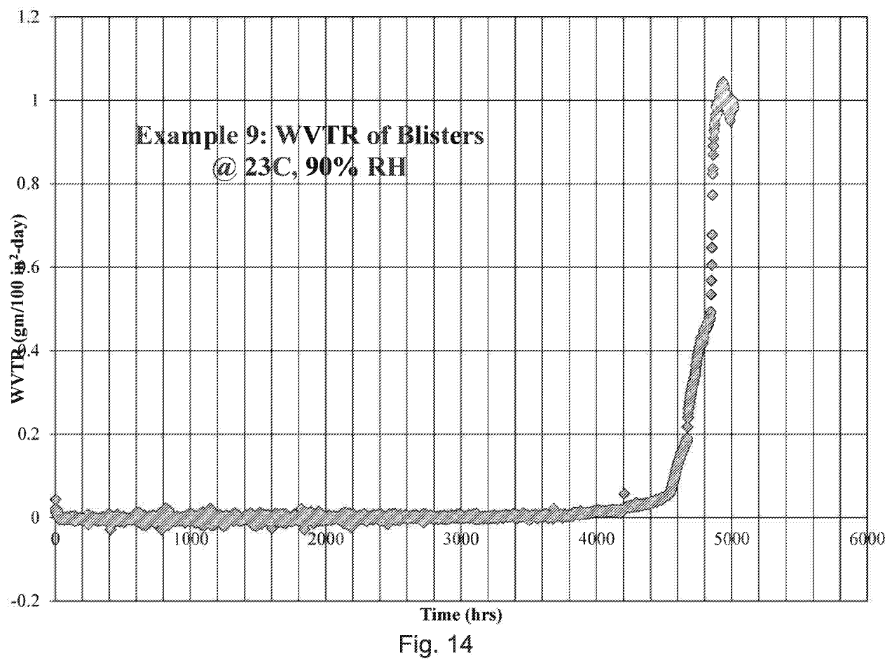

A flat sheet of Example 8 was aqueous coated with a primer layer and subsequently a passive moisture barrier layer to form the following structure: a first passive moisture barrier layer/a primer layer/a second passive moisture barrier layer/a first active moisture barrier layer/a third passive moisture barrier layer/a second active moisture barrier layer/a fourth passive moisture barrier layer. The dry coating thickness of the prime layer was 12.96 grams/m² and the primer layer was formed from DUR-O-SET® E351. The first passive moisture barrier layer was aqueous coated onto the primer layer and its target dry coverage was 85.5 grams/m². The first passive moisture barrier layer composition was made up of DARAN® SL112, i.e., a PVDC copolymer. The ratio of sum of the thicknesses of the active moisture barrier layers to the overall thickness is estimated to be 0.65:1. The coating quality was good and the sheets thermoformed well. The side opposite the side forming the blister cavity was the PVDC side. The blisters were characterized for WVTR with the PVDC side being exposed to moisture. The average blister thickness was 3.81 mil and the total surface area of the four blisters being characterized was 11.7 cm². FIG. 14 depicts the WVTR as a function of time.

### Example 10

This example investigated the creation of a coextruded structure: a first primer layer/a second passive moisture barrier layer/a first active moisture barrier layer/a third passive moisture barrier layer/a second primer layer. The second and third passive layer compositions and the active layer composition were the same as described in Example 5. The first and second primer layers were made of melt processable EVA, ALCUDIA® PA-420L. The adhesion of the EVA layer to the passive layer, as well as the adhesion of the passive layers to the active layer were all very good. The thickness of each layer from the first primer layer 1 onwards was found to be 0.59 mil, 1.19 mil, 9.68 mil, 1.12 mil, and 0.56 mil, respectively. The ratio of sum of the thicknesses of the passive moisture barrier layers adjacent to the active moisture barrier layer to the active moisture barrier layer thickness was found to be 0.24:1. The sample was thermoformed to form blisters without any cracks. The second primer layer can also serve as a sealant layer.

### Example 11

A roll formed in Example 10 was aqueous coated with a passive moisture barrier layer. The coated passive moisture barrier layer was DARAN® SL112 at a target dry coverage of 85.5 grams/m². The structure formed after coating resulted in: a first passive moisture barrier layer/a first primer layer/a second passive moisture barrier layer/a first active moisture barrier layer/a third passive moisture barrier layer/a second primer layer. The adhesion of the first passive moisture barrier layer to the first primer layer was found to be very good. Furthermore, thermoformability of this structure did not introduce any cracks. The structure formed had an estimated ratio of the thickness of the active layer to the total thickness of 0.65:1. An advantage of this structure is the second primer layer can also serve as a sealant layer.

### Example 12

A roll formed in Example 11 was aqueous coated with a passive moisture barrier layer on the side opposite to the first passive moisture barrier layer. This forms a fourth passive moisture barrier layer and also forms a sealant layer in certain applications, i.e., the selection of the type of passive moisture barrier layer defines its application. The coated passive moisture barrier layer was DARAN® SL112 at a target dry coverage of 28.5 grams/m². The structure formed after coating included: a first passive moisture barrier layer/a first primer layer/a second passive moisture barrier layer/a first active moisture barrier layer/a third passive moisture barrier layer/a second primer layer/a fourth passive moisture barrier layer. The adhesion of the fourth passive moisture barrier layer to the second primer layer was found to be very good. In this example, the compositions of the first passive moisture barrier layer and the fourth passive moisture layer are same. Wax coated paper was introduced as an interleaf during rolling of the structure to prevent blocking between surfaces. This structure exhibited acceptable thermoformability as no cracks occurred during forming. The formed structure, i.e., a blister pack, was sealed to foil lidstock.

### Example 13

This example investigates creation of the coextruded structure: a second passive moisture barrier layer/a first active moisture barrier layer/a third passive moisture barrier layer/a first primer layer. The second and third passive moisture barrier layer compositions and the first active moisture barrier layer composition is same as described in Example 5. The first primer layer was made of melt processable EVA, ALCUDIA® PA-420L. The adhesion of the EVA layer to the third passive moisture barrier layer, as well as the adhesion of passive moisture barrier layers to the active moisture barrier layer were all very good. The thickness of each layer from the second passive moisture barrier layer onwards was found to be 0.89 mil, 11.12 mil, 1.39 mil, and 0.30 mil, respectively. The total thickness of the structure was 13.71 mil. This structure was thermoformed successfully without any cracks with the primer layer being the layer that adheres to the foil lidstock. Hence, the primer layer serves as a sealant layer. Additionally, this example describes another complete structure that can be used in a sheet form where the primer layer performs the function of a sealant layer or a blister where the primer layer acts as a sealant layer to the to lidstock. The ratio of the sum of the thicknesses of the passive moisture barrier layers adjacent to the active moisture barrier layer to the active moisture barrier layer thickness was found to be 0.21:1 and the ratio of the thickness of the active moisture barrier layer to the total thickness was found to be 0.81:1.

### Example 14

This example uses the roll created in Example 13. A passive moisture barrier layer was aqueous coated onto the first primer layer to form the following structure: a second passive moisture barrier layer/a first active moisture barrier layer/a third passive moisture barrier layer/a first primer layer/a first passive moisture barrier layer. The first passive moisture barrier layer composition included DARAN® SL112 at a target dry coverage of 85.5 grams/m². As a result, this structure has a ratio of the thickness of the active moisture barrier layer to the total thickness of the structure of 0.71:1, while keeping the ratio of the sum of thicknesses of the passive moisture barrier layers adjacent to the active moisture barrier layer to the active moisture barrier layer thickness to be 0.21:1, i.e., the same as Example 12. The adhesion of the aqueous coated first passive moisture barrier layer to the extruded primer was found to be very good. There were no visible cracks. The structure was thermoformed to form blisters. In this example, the first passive moisture barrier layer side was the side facing the blister cavity and acted as the sealant layer to the lidstock. The structure could be thermoformed in the opposite orientation where the second passive moisture barrier layer faces the blister cavity.

### Example 15

A 5 mil active moisture barrier layer having a composition as described in Example 5 was made. The active moisture barrier layer was heat laminated to itself. The adhesion was found to be good and total sheet thickness was found to be 10 mil. A primer layer using DUR-O-SET® E351 was aqueous coated on the 10 mil active moisture barrier layer sheet. The coating quality was found to be good, but when characterizing the WVTR, it was found that exposure of the active moisture barrier layer directly to an aqueous coating compromised the capacity of the active layer.

### Example 16

A 5 mil active moisture barrier layer having a composition as described in Example 5 was made. The active moisture barrier layer was heat laminated to itself. The adhesion was found to be good and total sheet thickness was found to be 10 mil. This active moisture barrier layer sheet was then heat laminated to a 1 mil polypropylene sheet on both sides. This formed the passive moisture barrier layers on either side of the active moisture barrier layer. A primer layer using DUR-O-SET® E351 was aqueous coated on one of the passive moisture barrier layer sheets, whereon DIOFAN® A736, a PVDC copolymer, was aqueous coated. This example shows that lamination followed by aqueous coating can be used to create structures.

From the above examples, it has been shown that appropriate modification of the active moisture barrier layer to account for stiffness and high modulus of the filled cyclic olefin copolymer using an elastomer, and also surrounding the active moisture barrier layer with passive moisture barrier layers with modulus equivalent to or lower than the active moisture barrier layer enables effective post processing, e.g., thermoforming to form blisters.

For some of the above examples, WVTR data has not been presented since the active moisture barrier layer thickness was in the same range as the examples for which data was presented. Therefore, it is believed that the time lag should be similar. The examples highlight the versatility of the active moisture barrier layer composition and the technology to be able to provide alternate films or sheets which can be converted to packages such as blisters. Some of the variations highlight a one-step extrusion operation to create the final multilayer structure. Some of the structures, e.g., those created in Examples 10 and 13, could be used to laminate to other films like PVC on the side containing a primer layer. The primer layer composition in these examples could further be modified to enable adhesion to APET. It is believed that the presently disclosed embodiments of the multilayer structure and articles formed therefrom may be used in certain applications to eliminate the need for a foil layer and/or materials such as PCTFE.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed is:

1. A multilayer structure comprising, in order:
a first passive moisture barrier layer;
a second passive moisture barrier layer;
a first active moisture barrier layer comprising a first moisture absorbing composition and a cyclic olefin copolymer; and,
a third passive moisture barrier layer,
wherein the first, second and third passive moisture barrier layers and the first active moisture barrier layer are contiguous, non-contiguous or combinations thereof.

2. The multilayer structure of claim 1 wherein the first active moisture barrier layer comprises the first moisture absorbing composition in a range of greater than 10 wt % to less than or equal to 35 wt %.

3. The multilayer structure of claim 1 wherein the first moisture absorbing composition is selected from the group of: calcium oxide; silica gel; molecular sieve; and, combinations thereof.

4. The multilayer structure of claim 1 wherein at least one of the first, second and third passive moisture barrier layers is selected from the group of: polyethylene (PE); polyvinylidene chloride (PVDC); ethylene vinyl alcohol (EVOH); polychlorotrifluoroethylene (PCTFE); polyvinyl chloride (PVC); polypropylene (PP); polyethylene terephthalate glycol-modified (PETG); amorphous polyester (APET); polycarbonate; polyolefin; polyolefin copolymers; cyclic olefin copolymer (COC); high impact polystyrene (HIPS); acrylonitrile butadiene styrene (ABS); bi-axially oriented polyethylene terephthalate (BOPET); polystyrene; oriented polypropylene (OPP); polyester; acrylonitrile-methyl acrylate copolymers; ethylene vinyl acetate (EVA); and, combinations thereof.

5. The multilayer structure of claim 1 wherein the first passive moisture barrier layer is an aqueous solution prior to deposit on the second passive moisture barrier layer.

6. The multilayer structure of claim 5 wherein the first passive moisture barrier layer comprises polyvinylidene chloride (PVDC).

7. The multilayer structure of claim 1 further comprising:
a first primer layer disposed between the first passive moisture barrier layer and the second passive moisture barrier layer, wherein the first primer layer, the first active moisture barrier layer and the second and third passive moisture barrier layers are co-extruded.

8. The multilayer structure of claim 1 further comprising:
an overall thickness of less than or equal to about 508 microns.

9. The multilayer structure of claim 1 wherein the first active moisture barrier layer and the second and third passive moisture barrier layers are co-extruded.

10. The multilayer structure of claim 1 wherein a ratio of a sum of the thicknesses of the second and third passive moisture barrier layers to the thickness of the first active moisture barrier layer ranges from 0.18:1 to 0.61:1.

11. The multilayer structure of claim 1 further comprising:
a first primer layer disposed between the first passive moisture barrier layer and the second passive moisture barrier layer, wherein the first passive moisture barrier layer and the first primer layer are co-extruded onto an intermediate multilayer structure comprising, in order, the second passive moisture barrier layer, the first active moisture barrier layer and the third passive moisture barrier layer.

12. The multilayer structure of claim 1 further comprising, in order after the third passive moisture barrier layer:
a second active moisture barrier layer comprising a second moisture absorbing composition and a cyclic olefin copolymer; and,
a fourth passive moisture barrier layer,
wherein the first, second, third and fourth passive moisture barrier layers and the first and second active moisture barrier layers are contiguous, non-contiguous or combinations thereof.

13. The multilayer structure of claim 1 further comprising, after the third passive moisture barrier layer:
a fourth passive moisture barrier layer,
wherein the first, second, third and fourth passive moisture barrier layers and the first active moisture barrier layer are contiguous, non-contiguous or combinations thereof.

14. A thermoformed article formed from the multilayer structure of claim 1, wherein the second and third passive moisture barrier layers each comprise a modulus of elasticity less than or equal to a modulus of elasticity of the first active moisture barrier layer.

15. A container for extending the shelf life of moisture degradable pharmaceutical products comprising the thermoformed article of claim 14 forming a plurality of pill receiving chambers.

16. A method of forming a moisture absorbing multilayer structure comprising:
a) forming a base structure comprising, in order, a first passive moisture barrier layer, a first active moisture barrier layer and a second passive moisture barrier layer, the first active moisture barrier layer having a first side and a second side opposite the first side and comprising a first moisture absorbing composition and a cyclic olefin copolymer, the first passive moisture barrier layer disposed on the first side, and the second passive moisture barrier layer disposed on the second side; and,
b) coating a third passive moisture barrier layer on the base structure.

17. The method of forming a moisture absorbing multilayer structure of claim 16 wherein the third passive moisture barrier layer is disposed on a side of the first passive moisture barrier opposite the first active moisture barrier.

18. The method of forming a moisture absorbing multilayer structure of claim 16 wherein the first active moisture barrier layer comprises the first moisture absorbing composition in a range of greater than 10 wt % to less than or equal to 35 wt %.

19. The method of forming a moisture absorbing multilayer structure of claim 16 wherein to the first moisture absorbing composition is selected from the group of: calcium oxide; silica gel; molecular sieve; and, combinations thereof.

20. The method of forming a moisture absorbing multilayer structure of claim 16 wherein at least one of the first, second and third passive moisture barrier layers is selected from group of: polyethylene (PE); polyvinylidene chloride (PVDC); ethylene vinyl alcohol (EVOH); polychlorotrifluoroethylene (PCTFE); silicon oxide (SiOx); polyvinyl chloride (PVC); polypropylene (PP); polyethylene terephthalate glycol-modified (PETG); polycarbonate; polyolefin; high impact polystyrene (HIPS); acrylonitrile butadiene styrene (ABS); bi-axially oriented polyethylene terephthalate (BOPET); polystyrene; oriented polypropylene (OPP); polyester; acrylonitrile-methyl acrylate copolymers; ethylene vinyl acetate (EVA); and, combinations thereof.
